(19) United States
(12) Patent Application Publication
(10) Pub. No.: US 2017/0090571 A1
(43) Pub. Date: Mar. 30, 2017

(54) SYSTEM AND METHOD FOR DISPLAYING AND INTERACTING WITH ULTRASOUND IMAGES VIA A TOUCHSCREEN

(71) Applicant: General Electric Company, Schenectady, NY (US)

(72) Inventors: Steinar Bjaerum, Horten (NO); Anders Herman Torp, Oslo (NO)

(21) Appl. No.: 14/869,828

(22) Filed: Sep. 29, 2015

(51) Int. Cl. G06F 3/01; G06F 3/0488; G06T 7/00; G06F 3/041

(52) U.S. Cl. CPC G06F 3/016; G06F 3/0416; G06F 3/0488; G06T 7/0012; G06T 2207/10132

(57) ABSTRACT

Methods and systems are provided for providing tactile feedback via a touch-sensitive display of an imaging system. In one embodiment, a method comprises acquiring medical imaging data with a medical imaging device, generating an image from the acquired data, displaying the image on a touch-sensitive display, and during user touching of the displayed image, outputting tactile feedback via the display based on the acquired data. In this way, a user may more easily understand and evaluate a displayed image.

### FIELD

Embodiments of the subject matter disclosed herein relate to medical imaging, and more particularly, to techniques for displaying and analyzing ultrasound images.

### BACKGROUND

An ultrasound imaging system typically includes an ultrasound probe that is applied to a patient's body and a workstation or device that is operably coupled to the probe. The probe may be controlled by an operator of the system and is configured to transmit and receive ultrasound signals that are processed into an ultrasound image by the workstation or device. The workstation or device may show the ultrasound images through a display device. In one example, the display device may be a touch-sensitive display, also referred to as a touchscreen. A user may interact with the touchscreen to analyze the displayed image. For example, a user may use their fingers on the touchscreen to position a region of interest (ROI), place measurement calipers, or the like.

However, the inventors herein have recognized challenges with such touch based systems. For example, it may be difficult to achieve accurate positioning of the ROI or measurement calipers via the touch based system since the image details are hidden behind the user's fingertips. This may be especially difficult for small screens, such as those used in portable devices. Further, portable devices may be used in environments with poor lighting conditions, thereby making it difficult to see fine details of the displayed image and further decreasing a user's ability to accurately position analytical tools on the image, such as the ROI and measurement calipers.

### BRIEF DESCRIPTION

In one embodiment, a method comprises acquiring medical imaging data with a medical imaging device; generating an image from the acquired data; displaying the image on a touch-sensitive display; and during user touching of the display, outputting tactile feedback via the display based on the acquired data. In this way, the tactile feedback may allow a user to understand the displayed image and more easily place analytical tools (e.g., ROIs, measurement calipers, or the like) on the image without direct visualization of the displayed image. As a result, an ROI (or other analytical tool) may be more accurately positioned on the display.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows an example ultrasonic imaging system according to an embodiment of the invention.

FIG. 2 shows an example touch-sensitive display device capable of providing tactile feedback to a user.

FIG. 3 shows a flow chart illustrating a method for outputting tactile feedback via a touch-sensitive display.

FIG. 4 shows a flow chart illustrating a method for adjusting tactile feedback output via the touch-sensitive display based on operating conditions of the imaging system.

### DETAILED DESCRIPTION

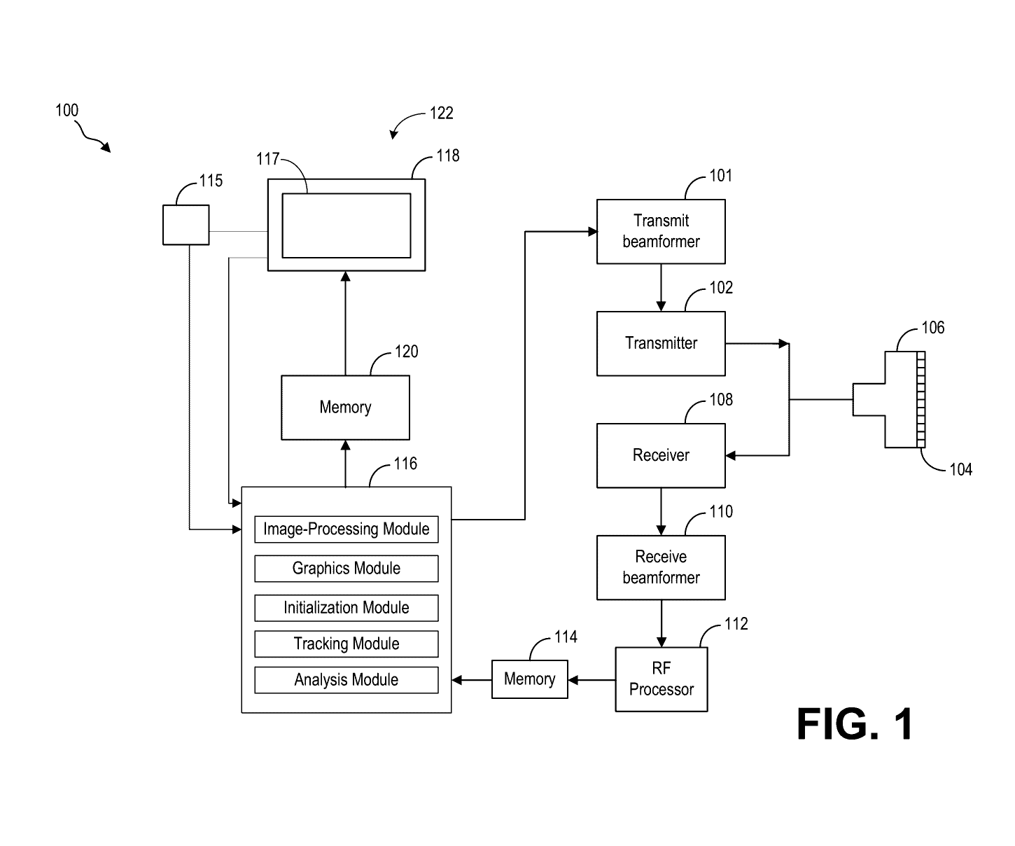

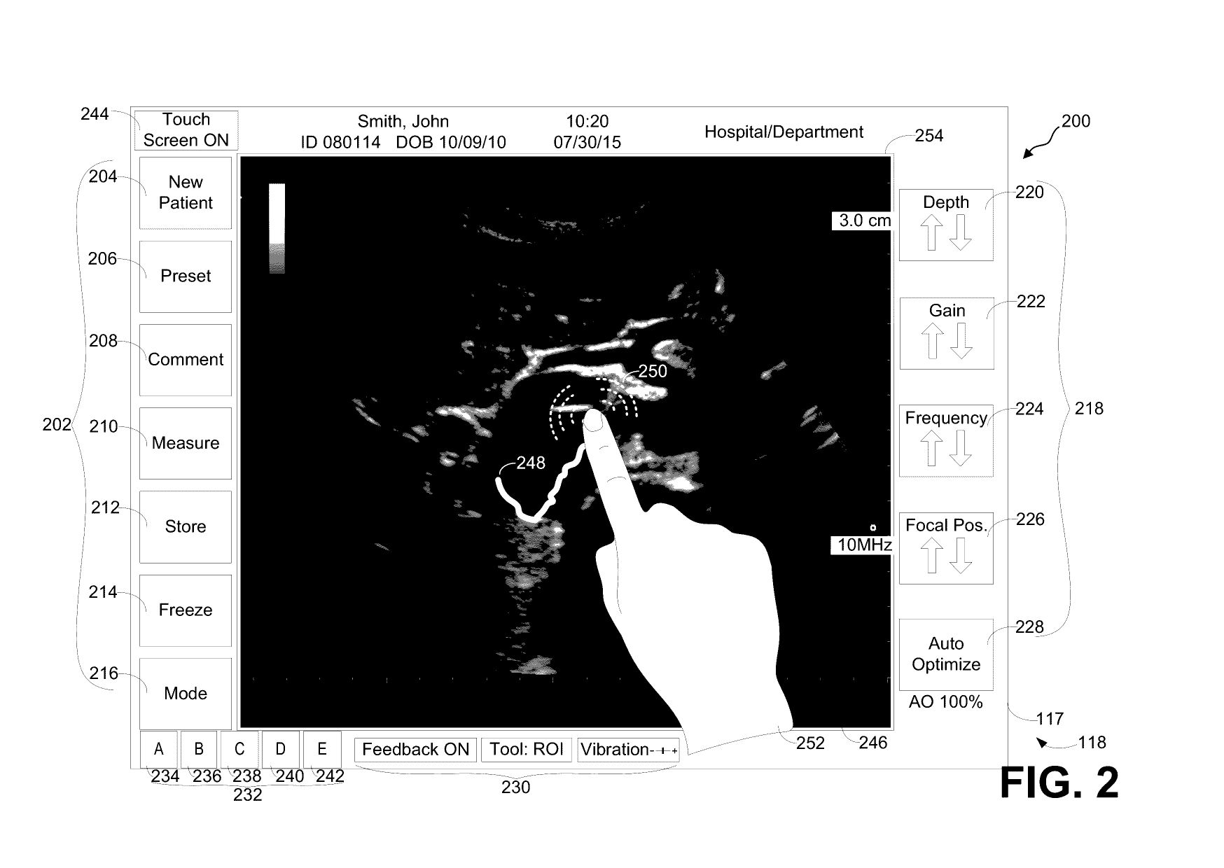

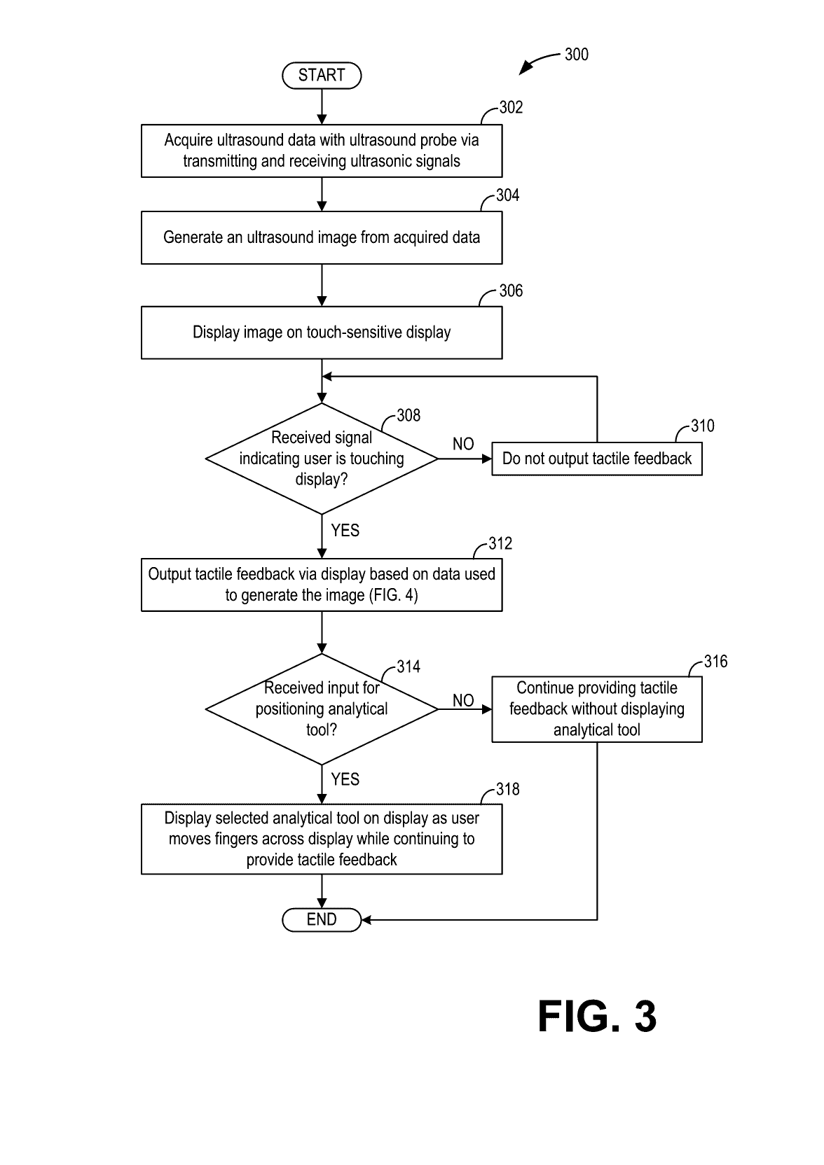

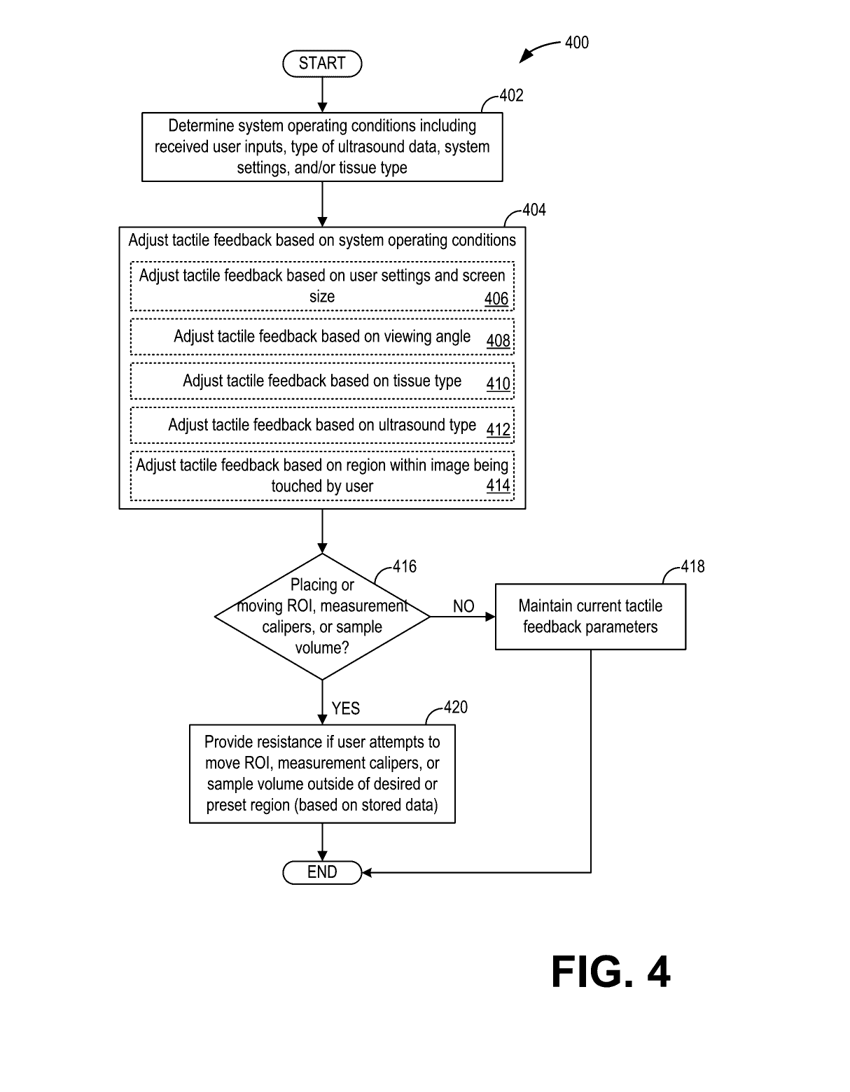

The following description relates to various embodiments of an imaging system, such as the ultrasound imaging system shown in FIG. 1. In particular, systems and methods are provided for providing tactile feedback via a touch-sensitive display of the imaging system, such as the touch-sensitive display shown in FIG. 2. As shown in FIG. 2, after acquiring imaging data (e.g., ultrasound imaging data), an image may be generated from the data and displayed via the touch-sensitive display. A user may touch the display, in a region of the displayed image. FIG. 3 presents a method for outputting tactile feedback via the touch-sensitive display in response to a user touching the displayed image. The tactile feedback (e.g., the intensity or type of tactile feedback) may be based on the data used to generate the image. A user may position an analytical tool, such as measurement calipers or a region of interest (ROI) on the displayed image while the display continues to provide tactile feedback. As shown at FIG. 4, the tactile feedback may be adjusted based on a plurality of operating conditions and/or user inputs of the imaging system. In this way, a user may more easily understand the displayed image and more accurately position an ROI, or other analytical tool, without direct visualization of the displayed image. Though the systems and methods described below for outputting tactile feedback via a touch-sensitive display are discussed with reference to an ultrasound imaging system, it should be noted that the methods described herein may be applied to a plurality of imaging systems (e.g., MRI, PET, X-ray, etc.).

FIG. 1 illustrates a block diagram of a system 100 according to one embodiment. In the illustrated embodiment, the system 100 is an imaging system and, more specifically, an ultrasound imaging system. However, it is understood that embodiments set forth herein may be implemented using other types of medical imaging modalities (e.g., MR, CT, PET/CT, SPECT etc.). Furthermore, it is understood that other embodiments do not actively acquire medical images. Instead, embodiments may retrieve image data that was previously acquired by an imaging system and analyze the image data as set forth herein. As shown, the system 100 includes multiple components. The components may be coupled to one another to form a single structure, may be separate but located within a common room, or may be remotely located with respect to one another. For example, one or more of the modules described herein may operate in a data server that has a distinct and remote location with respect to other components of the system 100, such as a probe and user interface. Optionally, in the case of ultrasound systems, the system 100 may be a unitary system that is capable of being moved (e.g., portably) from room to room. For example, the system 100 may include wheels or be transported on a cart.

In the illustrated embodiment, the system 100 includes a transmit beamformer 101 and transmitter 102 that drives an array of elements 104, for example, piezoelectric crystals, within a diagnostic ultrasound probe 106 (or transducer) to emit pulsed ultrasonic signals into a body or volume (not shown) of a subject. The elements 104 and the probe 106 may have a variety of geometries. The ultrasonic signals are back-scattered from structures in the body, for example, blood vessels and surrounding tissue, to produce echoes that return to the elements 104. The echoes are received by a receiver 108. The received echoes are provided to a receive beamformer 110 that performs beamforming and outputs an RF signal. The RF signal is then provided to an RF processor 112 that processes the RF signal. Alternatively, the RF processor 112 may include a complex demodulator (not shown) that demodulates the RF signal to form IQ data pairs representative of the echo signals. The RF or IQ signal data may then be provided directly to a memory 114 for storage (for example, temporary storage). The system 100 also includes a system controller 116 that includes a plurality of modules, which may be part of a single processing unit (e.g., processor) or distributed across multiple processing units. The system controller 116 is configured to control operation of the system 100. For example, the system controller 116 may include an image-processing module that receives image data (e.g., ultrasound signals in the form of RF signal data or IQ data pairs) and processes image data. For example, the image-processing module may process the ultrasound signals to generate slices or frames of ultrasound information (e.g., ultrasound images) for displaying to the operator. When the system 100 is an ultrasound system, the image-processing module may be configured to perform one or more processing operations according to a plurality of selectable ultrasound modalities on the acquired ultrasound information. By way of example only, the ultrasound modalities may include color-flow, acoustic radiation force imaging (ARFI), B-mode, A-mode, M-mode, spectral Doppler, acoustic streaming, tissue Doppler module, C-scan, and elastography. The generated ultrasound images may be two-dimensional (2D) or three-dimensional (3D). When multiple two-dimensional (2D) images are obtained, the image-processing module may also be configured to stabilize or register the images.

Acquired ultrasound information may be processed in real-time during an imaging session (or scanning session) as the echo signals are received. Additionally or alternatively, the ultrasound information may be stored temporarily in the memory 114 during an imaging session and processed in less than real-time in a live or off-line operation. An image memory 120 is included for storing processed slices of acquired ultrasound information that are not scheduled to be displayed immediately. The image memory 120 may comprise any known data storage medium, for example, a permanent storage medium, removable storage medium, and the like. Additionally, the image memory 120 may be a non-transitory storage medium.

In operation, an ultrasound system may acquire data, for example, volumetric data sets by various techniques (for example, 3D scanning, real-time 3D imaging, volume scanning, 2D scanning with probes having positioning sensors, freehand scanning using a voxel correlation technique, scanning using 2D or matrix array probes, and the like). Ultrasound images of the system 100 may be generated from the acquired data (at the controller 116) and displayed to the operator or user on the display device 118.

The system controller 116 is operably connected to a user interface 122 that enables an operator to control at least some of the operations of the system 100. The user interface 122 may include hardware, firmware, software, or a combination thereof that enables an individual (e.g., an operator) to directly or indirectly control operation of the system 100 and the various components thereof. As shown, the user interface 122 includes a display device 118 having a display area 117. In some embodiments, the user interface 122 may also include one or more user interface input devices 115, such as a physical keyboard, mouse, and/or touchpad. In one embodiment, a touchpad may be configured to the system controller 116 and display area 117, such that when a user moves a finger/glove/stylus across the face of the touchpad, a cursor atop the ultrasound image on the display device 117 moves in a corresponding manner. The touchpad may then provide tactile feedback to a user in the same ways described for a display area 117 to provide tactile feedback (as described further below). In an exemplary embodiment, the display device 118 is a touch-sensitive display (e.g., touchscreen) that can detect a presence of a touch from the operator on the display area 117 and can also identify a location of the touch in the display area 117. The touch may be applied by, for example, at least one of an individual's hand, glove, stylus, or the like. As such, the touch-sensitive display may also be characterized as an input device that is configured to receive inputs from the operator. The display device 118 also communicates information from the controller 116 to the operator by displaying the information to the operator. The display device 118 and/or the user interface 122 may also communicative audibly. The display device 118 is configured to present information to the operator during the imaging session. The information presented may include ultrasound images, graphical elements, user-selectable elements, and other information (e.g., administrative information, personal information of the patient, and the like).

In addition to the image-processing module, the system controller 116 may also include a graphics module, an initialization module, a tracking module, and an analysis module. The image-processing module, the graphics module, the initialization module, the tracking module, and the analysis module may coordinate with one another to present information to the operator during and/or after the imaging session. For example, the image-processing module may be configured to display an acquired image on the display device 118, and the graphics module may be configured to display designated graphics along with the ultrasound image, such as graphical outlines, which represent lumens or vessel walls in the acquired image. The image-processing and/or graphics modules within the system controller 116, may also be configured to generate a 3D rendering or image (not shown) of the entire vascular structure. In some embodiments the system controller 116 may also house an image-recognition module (not shown), which accesses stored images/videos (i.e., an image library) from either or both of the memory 114 and the memory 120, before analyzing them. For example, knowing the parameters under which a protocol is being carried out (ultrasound type, scan plane, tissue being imaged, etc.) the image recognition module may compare a live image on the display area 117, to one stored in memory 120, in order to analyze the image and thereby improve the accuracy of placing and utilizing analytical tools, as described later on with reference to FIG. 3. In an alternative embodiment, instead of utilizing an image recognition module and image library, the system controller may house instructions for analyzing acquired imaging date (e.g., ultrasound images/videos acquired with the probe) and automatically determining a desired placement of one or more analytical tools. For example, the controller may include algorithms stored within a memory of the controller for analyzing an acquired image and determining placement of an analytical tool, such as an ROI. In yet another embodiment, the system controller may utilize both an image recognition module (also referred to herein as stored image data) and separate instructions for analyzing the displayed image/video apart from an image library, and both of these approaches may be used to increase the accuracy of placing and utilizing analytical tools.

The screen of the display area 117 of the display device 118 is made up of a series of pixels which display the data acquired with the probe 106. The acquired data includes one or more imaging parameters calculated for each pixel, or group of pixels (for example, a group of pixels assigned the same parameter value), of the display, where the one or more calculated image parameters includes one or more of an intensity, velocity, color flow velocity, texture, graininess, contractility, deformation, and rate of deformation value. The series of pixels then make up the displayed image generated from the acquired ultrasound data. As mentioned above, the data acquired with the probe 106 and processed by the controller 116 may be 2D or 3D data. For example, traditionally, B-mode images, otherwise known as 2D images may be generated from A-mode information. A mode, where A stands for amplitude, is information of the reflected signal in a single ultrasound beam that is continually displayed as distance from the probe and intensity, are shown by position and amplitude in a line on an oscilloscope. A-mode information from many beams typically form a sector in a plane of the body, which is then shown as pixel intensity on a monitor, which is known as B-mode, where B stands for brightness. B mode may be used for anatomic assessment and orientation in the body, also for localizing and as a background display of other information such as Doppler signals. As such, B mode (2D) information may be used to identify a feature of interest and subsequently position a region of interest (ROI) that can then be manipulated for analysis of image content. As used herein, ROI refers to a border that either partially or fully encapsulates a feature of interest (such as a target tissue, organ, vessel lumen, tumor, etc.). In one embodiment, an ROI may be a user placed outline along the border of a feature of interest, as described later on with reference to FIG. 2. In an alternate embodiment, an ROI may be defined as a moveable box overlaying an acquired ultrasound image where color flow data is acquired.

Returning to B mode imaging, some manipulations may include implementation of an ROI around the feature of interest which is then subjected to image data content analysis, contrast intensity analysis, color Doppler velocity analysis, grayscale, calculation of mean, median and standard deviation of intensity per frame, graphical display of time vs intensity data, etc.

Placement of measurement calipers in 2D medical imaging may be used for acquiring measurement values of a feature of interest (e.g., fetus, tumor, organ etc.). Measurements can then be used in determining what stage of gestation a fetus is currently in, if a tumor is growing/shrinking, if an organ is unusually large due to inflammation, along with a plethora of additional calculations dependent on measurement values to produce an accurate diagnosis. It should be noted that being able to correctly identify a feature of interest within an image requires successful interpretation of pixel variances, that is to say, the user must be able to clearly identify the borders between varying anatomical features, referred to as line delineation. Successful line delineation allows differentiation between anatomical features, correct placement of ROI borders, and ultimately aids in whatever diagnosis can be made from the 2D imaging at hand.

A 3D medical imaging dataset acquired with the probe 106 includes a volume dataset including a plurality of voxels. Each voxel, or volume-element, is assigned a value or intensity. Additionally, each voxel may be assigned an opacity as well. The value or intensity may be mapped to a color according to some embodiments. As one example, a volume-rendered image may be generated from the 3D dataset using a ray casting technique. For example, the controller 116 may cast a plurality of parallel rays from a view plane of the display 118 (which comprises the series of pixels) through the 3D medical imaging dataset. It should be appreciated that multiple rays may be cast in order to assign values to all of the pixels within the view plane. The controller 116 may use a “front-to-back” or a “back-to-front” technique for volume composition in order to assign a value to each pixel in the view plane that is intersected by the ray. For example, starting at the front, that is the direction from which the image is viewed, the intensities of all the voxels along the corresponding ray may be summed. An opacity value, which corresponds to light attenuation, is assigned to each voxel. The intensity is multiplied by the opacity of the voxels along the ray to generate an opacity-weighted value. These opacity-weighted values are then accumulated in a front-to-back or in a back-to-front direction along each of the rays. The process of accumulating values is repeated for each of the pixels in the view plane in order to generate a volume-rendered image. In this way, each pixel used to form the image displayed on the display 118 may have an intensity, or brightness value associated with it.

The display device 118 is adapted to be touch-sensitive and provide tactile feedback to the user. The touch-sensitive display device 118 is capable of communicating with the controller 116 in order to deliver tactile feedback representing various structures and features of the image on the display area 117 of the display device 118. The tactile feedback output may be a function of the one or more calculated image parameters for one or more pixels (described above) in a region of the display being touched by the user. Tactile feedback may be in the form of vibration, applied voltage (perceived by the user as texture), thermal adjustment (such as heat), etc. and may be provided in varying degrees of intensity or frequency as a function of the one or more calculated image parameters for one or more pixels in a region of the display displaying the image and being touched by the user, in order to denote various features of the image. Said another way, the degree of tactile feedback output may be dependent on the value of one or more calculated image parameters of the one or more pixels on the display area 117. The display area 117 may offer tactile feedback when the user is attempting to manually construct a border around a feature of interest by providing vibrations that correspond to variances in greyscale. In one example, the degree of tactile feedback output may increase with a decreasing parameter value. For example, a user may manually attempt to construct a border between two tissue types on a bright interface. To aid in tracing the bright interface, the display area 117 may output increased tactile feedback (for example, a stronger vibration) when brightness is decreased. In another example, the degree of tactile feedback output may decrease with the decreasing image parameter value.

Such feedback could be implemented to more accurately place measurement calipers, denote border delineation, or target an area for Doppler sample volume, etc. Additionally, the system 100 may be capable of automatically placing measurement calipers, ROI boundaries, etc. into the correct position. In one embodiment, tactile feedback on the touch-sensitive display area 117 may provide resistance if the user attempts to move said calipers or ROI into an incorrect position. With respect to introducing a buffer for user error, the touch-sensitive display area 117 may also provide resistance during Doppler volume sampling should the user attempt to move the sample volume out of the target vessel. As an example, if the user then attempts to move the sample volume to an alternative vessel in the displayed image, then the output resistance may decrease and eventually disappear as the user approaches and then reaches the alternative vessel. For example, a user performing a Doppler sample volume may have positioned said Doppler sample volume in the center of a blood vessel. This positioning may have been done either by manual positioning or by an automated positioning algorithm. The image may contain more than one vessel, and the operator may be interested in measuring velocities (e.g., blood flow velocities) in another vessel. The system initially provides resistance when the operator starts to move the sample volume away from the center of the vessel because it does not make sense to measure blood velocities in the tissue surrounding the vessel. Despite the resistance, the user intentionally wants to move the sample volume to another vessel and chooses to discard the resistance. When the sample volume is moved and reaches a position closer to the new vessel than to the initial vessel, the resistance to movement (output via tactile feedback via the display) becomes smaller in the direction towards the new vessel. The sample volume may then gravitate towards the closest vessel. In one example, when sufficiently close to the second vessel, the sample volume may automatically snap into a position at the center of the second vessel. This may be accomplished by a combination of tactile feedback outputs, graphic display, audio signal, or any combination thereof. For example, the sample volume box may be bound to the user's finger but “pull” (via applied voltages perceived as frictional forces mimicking pulling) toward the second vessel, and once at the second vessel may graphically display a bouncing motion, to mimic snapping into position.

Touch-sensitive displays may introduce error by obfuscating the image beneath the user's hand, or when used in low light conditions. A touch-sensitive display area 117 capable of tactile feedback reduces the error introduced by relying on sight alone by providing physical feedback when crossing tissue boundaries, entering areas of various greyscale intensities, and introducing resistance when measurements and boundaries are moved from correct (e.g., desired based on user input and/or stored image data) to incorrect positions, thereby helping the user achieve a faster and more accurate analysis.

FIG. 2 is an illustration of an example screenshot 200 of the display device 118 according to one embodiment that provides touch screen and tactile feedback functionality. The screenshot 200 may be a screenshot of substantially all or a subpart of the viewable portion of the display area 117. The screenshot 200 includes an ultrasound image 246 that is at least partially surrounded by a plurality of touch-sensitive portions 202, 218, 230, and 232 of the display device 118 that are selectable by a user. In one example, the touch-sensitive portions 202, 218, 230, and 232 are not capable (e.g., do not provide) tactile feedback to the user touching these elements. Alternatively, substantially all of the display area 117 may be touch-sensitive and provide tactile feedback. Moreover, while one particular layout of the screenshot 200 is shown in FIG. 2, other layouts, positions and orientations of the various components of the screenshot 200 are possible.

Each of the touch-sensitive portions 202, 218, 230, and 232 includes a plurality of user selectable elements. One or more of the user selectable elements 204 through 242 represents a button or other interface capable of being touched by a user to control some aspect or feature of the associated imaging system (such as system 100 shown in FIG. 1) and/or to adjust the display of the ultrasound image 246. In an alternate embodiment, one or more of the functions selectable via the user selectable elements may be additionally or alternatively selected via multi-touch gestures on the touch-sensitive display (e.g., gestures performed by the user on the display screen). For instance, in lieu of a button to control some aspect of a user selectable element, the same aspect may be controlled by a downward swipe motion by the user. As one example in particular, in response to receiving a signal of a downward swipe motion by the user on the display, the system controller may increase a depth of the displayed image on the display.

The controls, operations, functions, and the like (collectively referred to as “image adjustments”) that are described below in conjunction with the various user selectable elements 204 through 242 are provided merely as examples and should not be construed as global limitations on one or more embodiments described herein. Furthermore, it is understood that when a user 252 selects any one of the user selectable elements described below, that the touch-sensitive display area 117 receives a signal initiated by the user touching a portion of the screen tied to a particular function (which function is indicated by the user selectable element). Having received an input signal from the user 252, the touch-sensitive area 117 relays the signal to the system controller (represented as 116 in FIG. 1). The system controller processes the signal accordingly before outputting a return signal to the touch-sensitive display area 117 of the display device 118 so that the user 252 may carry out an intended action. Moreover, it will be noted that the display area 117 described below is partitioned into two sections: a first touch-sensitive only portion, and a second touch-sensitive and tactile feedback emitting portion. The example touch-sensitive elements described below as part of the touch-sensitive portions 202, 218, 230, and 232 are solely touch-sensitive. However, in alternate embodiments, these touch-sensitive elements may also provide tactile feedback to the user. In this embodiment, the tactile feedback portion 254 of the touch-sensitive display area 117 is the only portion capable of producing tactile feedback in response to user 252 touch, as described in greater detail further on. Further the tactile feedback portion 254 may also be the portion of the display area 117 that displays the ultrasound image 246.

User selectable elements 204-216 included as part of touch-sensitive portion 202 may be positioned in a touch-sensitive portion of the display area 117, but they may not provide tactile feedback to the user 252. Titles for user selectable elements 204-216 are representative examples of what such elements may be, and are in no way limiting to all possible permutations. Touching the user selectable element 204 (in one embodiment, the “New Patient” user selectable element 204) may cause the system 100 to display patient information such as name, diagnosis, annotations, and the like, on the display device 118. Touching the user selectable element 206 (in one embodiment, the “Preset” user selectable element 206) may cause the system (such as system 100 shown in FIG. 1) to load and/or apply a set of imaging parameters (preferred imaging frequency, image depth, focal point, etc.) to the ultrasound image 246. Touching the user selectable element 208 (in one embodiment, the “Comment” user selectable element 208) may enable the operator of the imaging system to annotate the ultrasound image 246. Touching the user selectable element 210 (in one embodiment, the “Measure” user selectable element 210) may enable the operator of the imaging system to measure a feature in the ultrasound image 246. Touching the user selectable element 212 (in one embodiment, the “Store” user selectable element 212) may cause the system to save the ultrasound image 246 (and possibly annotations, measurements, and the like) on a computer-readable storage medium (such as memory 120 shown in FIG. 1), in one embodiment. Touching the user selectable element 214 (in one embodiment, the “Freeze” user selectable element 214) may cause the system to freeze the ultrasound image 246 and display the ultrasound image 246 as a static image.

Touch-sensitive element 216 represents a graphic model indicator in one embodiment. The graphic mode indicator indicates what imaging mode is being used by the imaging system to obtain the ultrasound image 246. For example, the graphic mode indicator may indicate that the imaging system is obtaining the ultrasound image 246 in any of B-mode, color, PW, PDI, M-mode imaging modes, and the like. In one embodiment, the graphic mode indicator may be displayed on a touch-sensitive portion such as on any of the touch-sensitive portions 202, 218, 230, and 232. The graphic mode indicator may then be touched to switch the imaging mode in which the imaging system is obtaining the ultrasound image 246. For example, the system controller (seen as 116 in FIG. 1) may toggle among the plurality of imaging modes each time the graphic mode indicator 216 is touched. Alternatively, the imaging system may populate a list of possible imaging modes on the display area 117 once the graphic mode indicator is touched. The operator of the imaging system may then touch the corresponding portion of the display area 117 that corresponds to the imaging mode in which the ultrasound image 246 is to be obtained. The system controller then switches the imaging mode of the imaging system.

User selectable elements 220-228 (collectively referred to as touch-sensitive portion 218) represent a touch-sensitive portion of the display area 117 that may not provide tactile feedback to the user 252. Titles for user selectable elements 220-228 are representative examples of what such elements may be, and are in no way limiting to all possible permutations. Touching any of the user selectable elements 220-228 sends a signal to the system controller that is processed according to the function of the user selectable element selected. A signal is then output from the system controller to the touch-sensitive display area 117 of the display device 118. In one embodiment, touching the user selectable element 220 (e.g., the “Depth adjustment” user selectable element 220) may cause the system controller to adjust the depth of the imaging field for the ultrasound image 246. Touching the user selectable element 222 (in one embodiment, the “Gain adjustment” user selectable element 222) may cause the system controller to adjust the gain of the ultrasound image 246. Touching the user selectable element 224 (in one embodiment, the “Frequency adjustment” user selectable element 224) may cause the system controller to adjust the frequency of the ultrasound image 246. Touching the user selectable element 226 (in one embodiment, the “Focal position adjustment” user selectable element 226) may cause the system controller to adjust the focal point of the ultrasound beams in the object being imaged to obtain the ultrasound image 246. Furthermore, each of the user selectable elements 220, 222, 224, and 226 may be subdivided into an increase portion and a decrease portion, signified by an upward arrow and a downward arrow, respectively. Touching the increase portion may cause the system controller to increase the depth of the imaging field/gain of the ultrasound image/frequency of the ultrasound beams/depth of the focal point of the ultrasound beams in the imaged object, respectively. Touching the decrease portion may cause the system controller to decrease the depth of the imaging field/gain of the ultrasound image/frequency of the ultrasound breams/depth of the focal point of the ultrasound beams in the imaged object, respectively.

Touching the user selectable element 228 (in one embodiment, the “Auto optimize” user selectable element 228) may cause the system controller to automatically adjust one or more imaging parameters. For example, based on a predetermined algorithm or logic, the system controller may automatically adjust imaging parameters such as the contrast of the ultrasound image 246 when the “Auto optimize” area 228 is touched.

In the illustrated embodiment, a value for each of the imaging parameters that are adjusted by touching the user selectable elements 220 through 228 is presented in a location that is proximate to the corresponding user selectable element 220 through 228. For example, as shown in FIG. 2, a current value of the imaging depth of 3.0 centimeters is presented by the display device 118 adjacent to the user selectable element 220, or the “Depth adjustment” area 220. Touching the “Depth adjustment” area 220 to adjust the imaging depth also causes the current value displayed on the display device 208 to change in a corresponding manner. For example, if the “Depth adjustment” area 220 is touched to increase the imaging depth, then the displayed value of the imaging depth also increases.

A graphic control indicator 244 is presented on the display area 117 in one embodiment. The graphic indicator 244 indicates whether the display area 117 or a user interface (such as user interface 122 and possibly 115 shown in FIG. 1) has control of the imaging system. For example, if the graphic indicator 244 indicates that the display device 118 has control of the imaging system, then the touch-sensitive portions 202, 218, 230, 232 may be used to control operations of the imaging system while the user interface may not be used to control the imaging system in one embodiment. Alternatively, if the graphic indicator 244 indicates that the user interface has control of the system 100, then the touch-sensitive portions 202, 218, 230 may not be used to control operations of the system 100 in one embodiment. In another embodiment, the graphic control indicator 244 is not presented on the display device 118.

One or more of the user selectable elements 234 through 242 (in one embodiment, the “Soft keys” 234 through 242) represents a control, operation, function, image adjustment, and the like, associated with an input component of a user interface (such as user input 115 shown in FIG. 1). For example, each of the “Soft key” user selectable elements 234-242, collectively referred to as touch-sensitive portion 232 may represent a keystroke, key or button on a keyboard of a user interface (such as user interface 115 shown in FIG. 1). Touching a “Soft key” of the touch-sensitive portion 232 causes the system controller to perform the same control, operation, function, image adjustment, and the like, that normally is associated with the associated keystroke, key or button of a user interface, in one embodiment. In another embodiment, the controls, operations, functions, adjustments, and the like, associated with the “Soft key” user selectable elements 234 through 242 change based on the imaging mode currently employed by the system (such as 100 in FIG. 1). Possible “Soft key” functions may include, but are not limited to, imaging controls (e.g., activating/deactivating a spatial compounding technique), activating/deactivating harmonic imaging techniques, enhancing a presentation or visualization of an associated peripheral device or apparatus in an ultrasound image, or activating/deactivating display of vascular bodies in an ultrasound image.

Additional “Soft key” functions may be associated with changing the direction of emitted ultrasound beams. For example, touching the “Soft key” user selectable element 234 may toggle a steering direction of the ultrasound beams. The ultrasound beams initially are emitted toward a center of the imaged body, and touching “Soft key” user selectable element 234 may change the steering direction between left, center, and right. Changing the direction of the emitted beams leads to an adjustment of viewing angle for the user. Change in viewing angle qualifies as a change in system operating conditions and may cause the system controller to adjust tactile feedback settings and output, as described below with reference to FIG. 4.

In the embodiment illustrated in FIG. 2, the touch-sensitive portion 230 encapsulates a number of user selectable elements controlling tactile feedback on the display area 117. One element may control whether the tactile feedback feature is enabled. Once the tactile feedback feature has been enabled, tactile feedback is provided to the user 252 through the tactile feedback portion 254 of the touch-sensitive display area 117. The tactile feedback provided to the user corresponds to underlying features of the ultrasound image 246 (e.g., the acquired ultrasound data used to generate the displayed ultrasound image 246). For example, the tactile feedback portion 254 of the display area 117 may output tactile feedback 250 in the form of vibration, applied voltage (perceived as texture), heat, etc. as the user 252 moves their finger (or glove, stylus, the like) over various edges in the image 246. Tactile feedback could also be provided in varying degrees of vibration, heat, etc. based on the brightness/graininess of the underlying image 246. In the event applied voltage is used as the mode of tactile feedback, the perceived texture of the screen may change beneath the user's finger/glove/stylus etc. to represent variations in brightness/graininess of the underlying image and thus the different structures (edges, protrusions, ridges, etc.) of the tissue which the image represents. Such feedback may help the user 252 to better sense when they are moving into areas with different greyscale intensities. Providing tactile feedback when hitting tissue boundaries or other features of interest helps a user to understand the geometrical and topographical features of the image, as well as the location to place a desired region of interest. Since image details are typically hidden behind the fingertip/glove/stylus of the user 252, the provided tactile feedback may allow a user 252 to more quickly and accurately position analytical tools, such as a region of interest or measurement calipers, on the displayed image using the touch based ultrasound system. Additionally, in portable systems, small screens and poor lighting can provide additional obstacles when trying to see the fine details of an image. Providing tactile feedback 250 to the user 252 can help in improving positioning accuracy of analytical tools on the displayed image and analyzing the displayed image in such smaller, portable systems.

One user selectable element within the touch sensitive portion 230 of the display area 117 may include a toolbox wherein the user may choose which parameters of tactile feedback they would like implemented. Toolbox features may include positioning measurement calipers, providing feedback specific to border delineation, positioning a region of interest (ROI), positioning a color ROI, or positioning a Doppler sample volume. In another embodiment, the imaging system may automatically snap an ROI, measurement caliper, etc. into a correct position. The system may then provide tactile resistance if the user attempts to move the ROI, measurement caliper, etc. away from the correct position, as described further below with reference to FIG. 4.

As exemplified in FIG. 2, one of the user selectable elements within the touch sensitive portion 230 of the display area 117 may allow the user to select or switch between various analytical tools. Looking to user selectable elements 230, the middle button “Tool:ROI” is meant to depict that user has selected and is currently engaging an ROI tool allowing the user to trace the outline of a region of interest 248. The user 252 would then attempt to trace the outline of a region of interest 248 (such as a vessel, organ, tissue boundary, fetus, tumor, etc.) on the displayed image 246. While the user 252 is interacting with the image via touch, the system controller (such as 116 in FIG. 1) sends signals to the appropriate region of the display area 117 to output tactile feedback 250 dependent on one or more preselected or preprogrammed parameters (e.g., mode, plane of view, feature of interest, greyscale intensity, pixel intensity, tissue velocity, contractility/strain, blood velocity, etc.). In the example shown in FIG. 2, the system uses border delineation (i.e., determining tissue boundaries based on pixel variance) to provide the user 252 with tactile feedback 250 in the form of vibration while the user traces the outline of a region of interest 248. In this embodiment, the controller of the imaging system outputs tactile feedback 250 that corresponds to the analytical tool selected by the user 252. It should be appreciated that the tactile feedback 250 may occur without selecting a specific tool, and may occur during a live ultrasound reading, or from a still shot stored in the memory (such as 120 in FIG. 1). In both cases the ultrasound image will not be disrupted while tactile feedback 250 is being emitted to the tactile feedback portion 254 of the display area 117.

Another user selectable element within the tactile feedback portion 254 of the display area 117 may allow the user 252 to manage tactile feedback preferences. For example, the user may choose heat as the mode of tactile feedback 250 and then alter the temperature intensity, output duration etc. It should be appreciated that depending on alternative parameters (e.g., ultrasound mode, type of test being performed, plane of view, etc.), the type of tactile feedback may not be alterable by the user 252. The user selectable elements of touch sensitive portion 230 that control tactile feedback may be presented as seen in FIG. 2, with a button each for turning tactile feedback on/off, selecting an analytical tool, and adjusting mode/intensity of tactile feedback. In alternate embodiments, the touch-sensitive portion 230 may include additional or alternative user selectable elements for controlling additional or alternative tactile feedback parameters. Tactile feedback may be provided to the user via the display during a live ultrasound, or from images stored in the memory of the imaging system (such as memory 114 and/or 120 shown in FIG. 1). Tactile feedback options may vary depending on the type of test being performed, the ultrasound mode being used, the plane of view, the feature being imaged (e.g., tissue type), etc. As explained above, the display device 117 is in communication with the controller (such as 116 in FIG. 1) of the imaging system. In one example, tactile feedback via the display may only be provided when the controller receives a signal that the user is touching the display. Upon receiving an indication that the user is touching the display (which is displaying the image), the controller may output tactile feedback through the display.

In the embodiment illustrated in FIG. 2, the ultrasound image 246 and the user selectable elements 204 through 242 are concurrently displayed on the display area 117. For example, the ultrasound image 246 and the user selectable elements 204-242 are presented in separate, non-overlapping areas of the display area 117 such that the ultrasound image 246 is not significantly obscured by one or more of the user selectable elements 204-242. The user selectable elements 204-242 thus may be displayed and used to adjust the ultrasound image 246 at the same time that the ultrasound image 246 is displayed on the display area 117.

In one embodiment, the imaging system permits the operator to touch one or more of the user selectable elements 204-242 as the ultrasound image 246 is obtained and/or displayed on the display area 117. For example, one or more of the user selectable elements 204-242 may be employed to adjust one or more settings of the imaging system to adjust the acquisition with display of the ultrasound image 246.

The set of user selectable elements 204-242 that is displayed in one or more of the touch-sensitive portions 202, 218, 230, and 232 is customizable in one embodiment. For example, an operator can select one or more of the user selectable elements 204-242 to be presented on the display area 117 in one or more of the touch-sensitive portions 202, 218, 230, and 232. The operator can customize which user selectable elements 204-242 are presented and save which user selectable elements 204-242 for later retrieval. For example, the set of user selectable elements 204-242 that is selected by the operator can be saved in one or more of the computer-readable storage media (e.g., memory 114, 120 shown in FIG. 1).

In this way, a touch-sensitive display of an ultrasound imaging system may allow a user to both select one or more operating parameter of the system and receive tactile feedback regarding the image content of the displayed image. As discussed further below with reference to FIGS. 3-4, the controller of the imaging system may output the tactile feedback via the display based on data acquired by a medical imaging probe. The tactile feedback may then be adjusted based on one or more system operating conditions of the imaging system.

Turning to FIG. 3, a flow chart of a method 300 for outputting tactile feedback via a touch-sensitive display of an imaging system is shown. The method 300 and other methods disclosed herein (e.g., method 400 shown in FIG. 4) may be performed with an imaging system, such as the ultrasound imaging system 100 shown in FIG. 1. More specifically, method 300 and the other methods disclosed herein may be executed by a controller of the ultrasound imaging system (such as controller 116 shown in FIG. 1) according to instructions stored on a non-transitory memory of the system (e.g., such as memory 120 shown in FIG. 1) in combination with the various signals received at the controller from the system components and actuation signals sent from the system controller to the display device. However, according to other embodiments, the methods 300 and 400 may also be performed with other ultrasound imaging systems or with different medical imaging devices (e.g., such as MRI, PET, X-ray, or other similar systems). Additionally, according to other embodiments, the method 300 may be performed by a workstation that has access to ultrasound data that was acquired by a separate ultrasound imaging system.

Method 300 begins at 302, where the ultrasound imaging system acquires a medical imaging dataset with an ultrasound probe (such as ultrasound probe 106 shown in FIG. 1). For example, once the probe is positioned on an object surface, the controller actuates the probe to emit pulsed ultrasonic signals into a body or volume of a subject, as described above with reference to FIG. 1. The ultrasonic signals are back-scattered from structures in the body, producing echoes that return to the elements of the probe. The echoes are received by a receiver (such as receiver 108 show in FIG. 1), then a beam former (such as beam former 110 shown in FIG. 1), which outputs an RF signal. The RF signal may then be transmitted to an RF processor (such as RF processor 112 shown in FIG. 1) which outputs RF signal data, or if the RF processor contains a complex demodulator, IQ signal data is output.

At 304, the method includes generating an ultrasound image from the acquired ultrasound data. For example, the signal data acquired during the method at 302 is then processed and analyzed by the system controller (e.g., such as controller 116 shown in FIG. 1) in order to produce an ultrasound image. The system controller may include an image-processing module that receives the signal data (e.g., image data) acquired at 302 and processes the received image data. For example, the image-processing module may process the ultrasound signals to generate slices or frames of ultrasound information (e.g., ultrasound images) for displaying to the operator. In one example, generating the image may include determining an intensity value for each pixel of a display screen (e.g., touch-sensitive display 118 shown in FIGS. 1-2) based on the received image data (e.g., 2D or 3D ultrasound data). As such, the ultrasound images may be two-dimensional (2D) or three-dimensional (3D) depending on the mode of ultrasound being used (e.g., color-flow, acoustic radiation force imaging (ARFI), B-mode, A-mode, M-mode, spectral Doppler, acoustic streaming, tissue Doppler module, C-scan, and elastography).

At 306, the method includes displaying the generated ultrasound image on a touch-sensitive display (e.g., such as touch-sensitive display 118 shown in FIG. 1). For example, the method at 306 may include the real-time display of the generated images while data is being acquired with the ultrasound probe. Alternatively, images stored in the memory of the ultrasound system (such as memory 114, 120 of system 100 shown in FIG. 1) may be accessed following an imaging event and displayed on the touch-sensitive display. The display screen of the touch-sensitive display may be on a computer display, tablet, portable imaging device, etc. so long as it is touch-sensitive and configured for tactile feedback, as described in greater detail below.

At 308, the method includes determining if the controller has received a signal indicating that the user is touching the display. For example, when a user touches the touch-sensitive display, a signal may be sent to the controller. More specifically, the method at 308 may include determining if the controller has received a signal indicating that the user is touching the display in a region of the display where the image is displayed (e.g., a region adapted to provide tactile feedback). If the controller has not received a signal indicating that a user is touching the screen in an area designed to output tactile feedback, the method continues to 310 to not output tactile feedback via the display. The method at 310 may further include maintaining current imaging parameters used to display the image on the touch-sensitive display.

It will be appreciated that a portion, all, or none of the display screen of the display may be receptive to a user's touch as a signal to output tactile feedback. For example, FIG. 2 represents one embodiment where the entire display screen is touch-sensitive, but only a portion of the display screen is adapted to output tactile feedback. For example, the sections that include user selectable elements (e.g., sections 202, 218, 232, and 230 shown in FIG. 2) may be adapted to provide inputs to the controller, but are not capable of providing tactile feedback to the user that relates to the displayed image. In another embodiment, the user selectable elements may provide tactile feedback to the user related to the elements themselves, but not related to image content of the displayed ultrasound image (e.g., since these portions of the screen may not include the displayed image). In an alternative embodiment, the display screen may lack touch-sensitive user selectable elements entirely, and have only a touch-sensitive toolbar controlling tactile feedback options. In yet another embodiment, both the user selectable elements and tactile feedback elements may be controlled through external user interfaces (such as 115 in FIG. 1) such as a keyboard, mouse, tablet etc. and the entire display screen may be receptive to any touch as a signal to output tactile feedback. These embodiments are not limiting to all possible permutations of touch screen displays, and should only be viewed as several examples of possible permutations.

Returning to 308, if the controller receives a signal indicating that a user is touching the display in an area of the display adapted to output tactile feedback related to the displayed image (e.g., in a region of the display that displays the image), the method continues to 312. At 312, the method includes outputting tactile feedback via the display based on the data used to generate the image. A method for adjusting tactile feedback according to a plurality of parameters is described in further detail below with reference to FIG. 4. At 312, the display may provide tactile feedback to represent various structures in the displayed image. For example, as a user finger crosses over a tissue boundary (e.g., edge) the tactile feedback being received may change to indicate to the user that an edge, or another feature, has been crossed. The change in tactile feedback may include a change in frequency, intensity, duration, friction, etc. of the outputted tactile feedback. The tactile feedback may be provided to the user via the display for a duration of the user's contact with the display screen (i.e., as long as the controller is receiving a signal that the user is touching the display in the region of the displayed image that is adapted to provide tactile feedback). The tactile feedback is provided to the user while (e.g., at the same time) the image is being displayed via the display.

Outputting tactile feedback at 312 may include one or more of outputting vibration, thermal adjustment (such as heat), applied voltage affecting frictional forces between the user and the displayed image (e.g., perceived as texture), or another type of tactile feedback via the display. As one example, tactile feedback may be output via the display when a user crosses over various tissue boundaries in an image. In another example, tactile feedback may be output as various degrees of vibration or heat that is proportional to and representative of the underlying brightness/graininess of the portion of the image being touched by the user. In one embodiment, the type, magnitude, or duration of tactile feedback output by the display may be based on one or more image parameters assigned to the pixels on the display region touched by the user. The one or more image parameters may include intensity, velocity, deformation, etc. assigned to pixels on the display region touched by the user. For example, if the one or more image parameters is an intensity value, as the intensity value of the pixel(s) being touched by the user increases, the amount (or intensity/magnitude of) the tactile feedback may increase. In this embodiment, the pixel intensity may be representative of acquired ultrasound data in B mode, as described above with reference to FIG. 1. Increased pixel intensity may then correspond to a stronger vibration, or more heat. Decreased pixel intensity may correspond to less or no vibration, and removal of heat from the portion of the screen receiving user input. In another embodiment, tactile feedback may be based on the intensity value of voxels, used commonly during 3D imaging, as also described above with reference to FIG. 1. In this way, one or more image parameters, such as an intensity value, assigned to each voxel during the generation of the ultrasound image at 304 may then be correlated to a tactile feedback value. In the 3D imaging embodiment the user may select applied voltage translating to frictional forces perceived as texture as the mode of tactile feedback. When using applied voltage as the mode of tactile feedback, the user may receive perceived depth and elevation information regarding the displayed image when touching the 3D rendered image. It will be appreciated that tactile feedback in the form of applied voltage may also be used for 2D images, outputting different types of applied voltage that correspond to underlying brightness/graininess, greyscales, tissue boundaries, etc. Furthermore, it will be appreciated that a number of attributes derived from ultrasound data acquired with the ultrasound probe may be used as the source of tactile feedback, such as blood velocity, tissue velocity, contractility/strain, deformation, etc., in addition to the aforementioned image brightness (e.g., pixel intensity). Additionally, more than one attribute at a time may be used to generate tactile feedback output. For example, tactile feedback output may be based on a combination of blood velocity estimates and pixel intensity (as described further below with reference to 412 of FIG. 4).

At 314, the method includes determining via the controller whether or not input has been received for positioning an analytical tool on the displayed image. As an example, the user may move a finger (or glove, stylus, etc.) across the display and upon doing so, receive tactile feedback to aid positioning of an analytical tool. At a given position, the user determines they are in the correct position for the analytical tool. The user may then push down on the touch screen display at the selected position, prompting a menu to pop up for selecting among a list of different analytical tools. The list could contain analytical tools such as a Doppler cursor, color flow ROI, distance caliper, edge tracer, etc. The user may then tap at the desired list item to select the desired analytical tool. In an alternative embodiment, method 300 may transpire in a system including a force sensitive touch screen display. Force sensitive touch screens may detect the applied force (applied via a user's fingers, hands, or stylist) when the user pushes against the touch screen. Different actions may then be taken depending on the applied force. For example, force sensitivity may be utilized as an alternative way of selecting the type of analytical tool. At 314, the user may be at the desired position, and wishing to utilize an analytical tool, the user may push down against the force sensitive touch screen and hold their position. Depending on the applied force, the system may then automatically scroll through a list of analytical tools. The user may then select the desired analytical tool by quickly releasing the pressure when the desired tool is highlighted. For instance, if a Doppler cursor is selected, the system may automatically enter Doppler mode with the sample volume at the selected position. If the user decides to move the Doppler sample volume, the user may touch and grab the sample volume graphics overlay on the screen, move it around on the screen while receiving tactile feedback based on the underlying image, and release it at the desired modified position. Alternatively, if a color flow ROI is selected, the system may automatically enter color flow mode with the color ROI centered at the selected position. If the user chooses to move the color flow ROI, the user may touch and grab the color box, move it around on the screen while receiving tactile feedback, and release it at the desired modified position. Furthermore, if a measurement caliper, an edge tracer, or similar tool is selected, the interaction with the tool will start at the selected position. The operator may move around the analytical tool on the touch screen while receiving tactile feedback to more efficiently operate the tool. As described above, possible analytical tools may include measurement calipers, region of interests (ROIs), a Doppler sample volume, a color ROI, etc. Additional tools may allow the system to automatically place measurement calipers, ROIs or Doppler sample volumes onto the ultrasound image. Furthermore, the system may provide resistance to the user if the user attempts to move the selected tool from the location corresponding to a desired location (e.g., a pre-determined location based on one or more of user input and stored medical imaging data). Lastly, the system may be able to bounce a Doppler sample volume back into its designated vessel in the event the user drags it out of said vessel. The analytical tools may be positioned/placed on the displayed image during a live scan or on a saved image/video. It will be appreciated that the automatic algorithms for positioning analytical tools may be based on analysis of the generated image on the display screen (i.e., acquired in real time or retrieved from memory). Furthermore, it will be appreciated that more advanced algorithms may improve the accuracy of analytical tool placement and utilization by incorporating knowledge obtained by analysis of images stored in a database (such as, an image-recognition module within a system controller).

If the controller 116 has not received a signal indicating implementation of an analytical tool, the method continues to 316 to continue providing tactile feedback via the display without displaying an analytical tool. Method 300 may then end. Alternatively at 314, if the controller has received an input via the touch-sensitive display for positioning of an analytical tool, the method continues to 318. At 318, the method includes displaying the selected analytical tool on the display as a user moves their fingers across the display while continuing to provide tactile feedback. In some embodiments, the method at 318 may include prompting the user, via the display, to choose which analytical tool is desired, if the user only generically selected placement of an analytical tool at 314. In one embodiment, selection of the analytical tool may come from a user selectable element on a tactile feedback portion of the display that displays tactile feedback user selectable elements (e.g., as shown at 230 in FIG. 2). In another embodiment the analytical tool may be selected by an external user interface such as a mouse, keyboard, tablet etc. Alternative embodiments may also be used for analytical tool selection

Returning to 318, the method at 318 may include adjusting the tactile feedback output via the display during placement of the analytical tool based on which analytical tool is selected. For example, an intensity, type (e.g., vibration, applied voltage, heat, etc.), frequency, or duration of the tactile feedback may be different when measurement calipers are placed at 318 than when an ROI is placed

As an example, the controller may receive an input at 314 for positioning measurement calipers. After selecting measurement calipers, the user may slide their finger (or stylus, glove, etc.) over a border in the image generated by the boundary of a feature of interest (organ, fetus, tumor, luminal space etc.). Upon the user crossing the border in the image, the controller may output via the display a first tactile feedback signal (vibration, various voltage levels, heat, etc.). As a result of feeling this tactile feedback, the user may place an origin point of the measurement calipers before continuing to slide their finger across the feature of interest until another border is met, where they then receive a secondary tactile feedback signal and subsequently place the end point of the measurement calipers. It should be appreciated that this is one embodiment of how measurement calipers may work and that tactile feedback parameters may be adjusted in a multitude of ways. In another embodiment, the user may select an analytical tool used for ROI placement. The user may trace the outline of a region of interest (such as region of interest 248 in the image 246 shown in FIG. 2) in the displayed image and receive various types of tactile feedback while doing so. One possibility includes providing tactile feedback to the entire image, regardless of whether the user is inside or outside the ROI. In this embodiment, the user may use the tactile feedback to determine where to trace/position the ROI. Another possibility includes only providing tactile feedback to the user if the user is within the ROI or within a threshold distance of the ROI, as determined by an image database stored in the memory of the device. Another example of tactile feedback pertaining to an ROI tool could involve not supplying tactile feedback while the user is tracing/placing an ROI unless the user strays too far from the border of the feature of interest. In this instance, tactile feedback would be provided as a warning signal to the user to adjust where the ROI border is being placed. As with the ROI tool, a plurality of tactile feedback parameters may be possible for each analytical tool. Additionally, the analytical tools listed as examples are not an exhaustive list of all possible analytical tools that engage with tactile feedback on a touch-sensitive display. The method may end after conclusion of the placement of the selected analytical tool.

In this way, the method 300 allows placement of a selected analytical tool atop the displayed ultrasound image on the touch-sensitive display as the user continues to provide input to the touch-sensitive display (via fingers, glove, stylus, etc.), while receiving tactile feedback based on data content of the acquired image via the display. It will be appreciated that the acquired image may be an image or video from the memory of the system, or from a live acquisition. In the event of a live acquisition, the displayed image and tactile feedback may be continuously updated, concertedly, based on the acquired data.

FIG. 4 is a flow chart of a method 400 for adjusting tactile feedback output via the touch-sensitive display based on operating conditions of the imaging system. Method 400 may be performed as part of the method at 312 in FIG. 3. As such, the controller of the medical imaging system may execute method 400 according to instructions stored in the non-transitory memory of the imaging system.

Method 400 begins at 402 by determining the system operating conditions of the imaging system, including one or more of received user inputs, the type of ultrasound data used to generate the displayed image, system settings of the imaging system, and/or the type of tissue represented by the displayed image. Received user inputs may include inputs received from the display screen indicating the user touching the displayed image with a finger, glove, stylus, or any additional component suited for successfully transmitting the signal of physical interaction with the touch-sensitive screen to the system controller. Additionally, the user input may not be singular in nature, that is, user input may include multiple inputs from more than one finger (or styluses, etc.) touching the screen at a given time. Further, received user inputs may include one or more inputs selected from various user selectable elements displayed via the display. Such user selectable elements may affect ultrasound imaging mode, display area size (i.e., screen size), zoom, viewing angle, frequency of ultrasound beams, or auto optimization of image, to name a few. More examples of user selectable elements are described above with reference to the touch sensitive portions 202, 218, 230, and 232 of FIG. 2. The type of ultrasound data used to generate the displayed image may include 2D or 3D data obtained with different imaging modalities such as color-flow, acoustic radiation force imaging (ARFI), A-mode, B-mode, C-mode, M-mode, pulse inversion mode, harmonic mode, contrast ultrasonography (ultrasound contrast imaging), molecular ultrasonography (ultrasound molecular imaging), elastography (ultrasound elasticity imaging), compression ultrasonography, and a variety of Doppler modes (color Doppler, continuous Doppler, pulsed wave Doppler, duplex, and triplex). In addition to user inputs and the type of ultrasound data, the controller may also determine the tissue type being imaged. For example, if the user wishes for tactile feedback specific to a tissue type, they may have to communicate to the system what is being imaged, as this will affect the parameters controlling tactile feedback. For instance, if imaging a fetus the system will look for and respond to a cluster of bright pixels (i.e., fetal tissue) surrounded by a dark background (i.e., uterine cavity). Comparatively, when preforming a color Doppler, the system will already know the parameters surrounding the tissue type (i.e., blood flow) within a vessel where velocity information is presented as a color-coded overlay on top of a B-mode image. Determining operating conditions also includes taking system settings into account. As one example, system settings of the ultrasound system may include a size of the displayed image (e.g., size of the display area used for displaying the image), an image resolution, a speckle reduction setting, greyscale settings, or the like.

At 404, the method includes adjusting the tactile feedback output via the display (e.g., the tactile feedback output at 312 during method 300) based on the system operating conditions determined at 402. Adjusting tactile feedback at 404 may include adjusting one or more of the type of tactile feedback (e.g., vibration, applied voltage, heat, electrical pulses, etc.), the frequency of the tactile feedback (e.g., the frequency of the vibration), the duration of the tactile feedback (e.g., how long each vibration or pulse lasts as a user crosses their fingers over a pixel or region of the touch-sensitive display), and the magnitude of the tactile feedback (e.g., the strength of the vibration, the strength of the applied voltage, heat, pulse, etc. output by the display). The tactile feedback may be adjusted based on one or more of the system operating conditions. More specifically, adjusting the tactile feedback at 404 may include adjusting the tactile feedback by one or more of the methods shown at 406-414, as described further below.

As one example, adjusting the tactile feedback may include, at 406, adjusting tactile feedback output via the display based on the user selected settings and screen size. User selected settings may include the type of tactile feedback, whether that be vibration, applied voltage, heat, etc. The user selected settings may further include the intensity of the tactile feedback (e.g., as shown in the example in FIG. 2, this may include a sliding bar representing a sliding scale of intensity values), the duration of tactile feedback, or a pattern of the tactile feedback. The duration of tactile feedback may include a length of time in which the feedback is output at a single location on the screen. The pattern of tactile feedback may include different patterns of feedback, where specific patterns are meant to impart different information to the user. For example, a series of fast pulses may indicate the user has crossed a tissue boundary within the image. Screen size may also influence the tactile feedback due to the gain/loss of resolution with smaller and larger screens. For example, compression of data on a smaller screen may limit the variety of tactile feedback that may be possible on a larger screen. Certain feedback tools described in FIG. 3 may require a screen above a minimum size, or a screen that is capable of showing colored pixels. It should be appreciated that engaging a zoom feature may serve to increase or decrease the size of the image on the display, thereby leading to a change in resolution. As a result, the tactile feedback parameters may be adjusted based on one or more of the screen size and a selected zoom setting.

At 408, the method includes adjusting tactile feedback based on viewing angle. The viewing angle may be defined as an angle at which the user views the ultrasound image on the screen relative to a direction of the probe axis used to acquire the image. Ultrasound imaging is anisotropic in nature, that is, the reflected signal from large scale tissue boundaries is dependent on the incident angle of the beam. For 2D and 3D images, changing the angle of the probe will change the landscape of the image. However, the resolution of the image may be anisotropic, for example, when the ultrasound image is acquired at fundamental frequencies. As such, the image resolution changes from a radial viewing direction (e.g., a direction normal to the transducer probe surface and in a direction of a probe axis of the transducer probe) to a lateral (e.g., a direction perpendicular to the transducer probe surface normal, also referred to herein as a side view) and elevation viewing direction. For example, when 3D ultrasound data is viewed from the lateral direction, the resulting volume-rendered image has a more noisy and unstable appearance than when the ultrasound data is viewed from the radial direction. Many of the shadows and reflections created in the lateral view volume-rendered image may not correspond to real structures, thereby degrading the ability of the user to make an accurate medical diagnosis. If the system is aware of what viewing angles lead to increased visual artifacts it may be able to adjust tactile feedback output accordingly. For example, the system may adjust thresholds for outputting tactile feedback in an image prone to visual artifacts. Alternatively, the system may cross reference the ultrasound image with an image recognition database (described further below) to determine what in the image qualifies as tissue/tissue features and what is likely to be an artifact, and then adjusting tactile feedback output accordingly.

As yet another example, adjusting the tactile feedback may include, at 410, adjusting the tactile feedback based on tissue type. As mentioned in 408, tissue types may have different imaging qualities depending on the viewing angle. Tissue types may have inherent intensities, opacities and gradients that can be used by the system controller to automatically identify the tissue. Being able to identify a specific tissue type, or being able to distinguish between multiple tissue types at a time could allow the system to engage in different types of tactile feedback. For example, presuming the system knows that the user is trying to image a liver, and knows the viewing angle being used, the system controller may be able to distinguish the liver from neighboring tissues or luminal spaces and adjust tactile feedback output accordingly. Tactile feedback adjustments may include adjusting the intensity as a whole based on tissue type, or having patterns of output that correspond to various image contrasts, different types of edges or different structures. In this way, the user may be able to identify various tissue types based on type of tactile feedback output.

As another example, adjusting the tactile feedback may include, at 412, adjusting the tactile feedback based on ultrasound type. Specifically, the method at 412 may include providing tactile feedback with a first set of parameters (e.g., intensity, frequency, duration, sensitivity, etc.) for a first ultrasound imaging type and providing tactile feedback with a different, second set of parameter for a different, second ultrasound imaging type. For example, for the first ultrasound imaging type, the first set of parameters may include outputting tactile feedback with an overall higher intensity and for a longer duration that for the second ultrasound imaging type. While the basic feature of providing tactile feedback as the user drags a finger, stylus, etc. over a tissue boundary (i.e., via border delineation) is possible with most types of ultrasound imaging (A-mode excluded), certain tools may be ultrasound mode dependent. For instance, assistance positioning a Doppler sample volume via tactile feedback may only be available in Doppler mode. In another example, for 3D volume rendering, a volume rendering algorithm controlling the shading of an image may calculate how the light would reflect, refract, and diffuse based on intensities, opacities, and gradients in a 3D ultrasound imaging dataset. The intensities, opacities, and gradients in the 3D ultrasound imaging dataset may correspond with tissues, organs, and structures in the volume-of-interest from which the 3D ultrasound dataset was acquired. When the system controller knows that a 3D ultrasound is being implemented, it may adjust the thresholds and triggers for tactile feedback for a particular tissue type or feature of interest. For example, the parameters used for outputting tactile feedback in an image of a liver tissue in B-mode imaging may be different from the parameters used for outputting tactile feedback when imaging blood vessels during a 3D ultrasound (such as a Spectral Doppler). The parameters for B-mode imaging may be pixel intensity, while the parameters for 3D Doppler mode may be velocity. For example, a user performing a Spectral Doppler may be interested in an accurate quantitative number for the maximum blood velocity inside a color flow ROI. The color flow provides a display of the spatial distribution of the blood velocities, but the velocity estimates may not be very accurate. Spectral Doppler provides accurate velocity estimates at the location of the sample volume. Provided that the sample volume is positioned at the correct spot, the maximum velocity can be derived from the Doppler spectrum. The sample volume is positioned using the touch screen. The color flow velocity values can then be used as the source for the tactile feedback when positioning the Doppler sample volume, thereby guiding the placement of the sample volume to the position of highest velocity. It will be appreciated that tactile feedback output may not be based on one parameter (such as velocity) alone, but on multiple parameters at once (such as velocity and image brightness).

This may be due to the fact that the processing algorithms and additional modules of the imaging system controller may vary according to ultrasound mode.

As yet another example, adjusting the tactile feedback may include, at 414, adjusting the tactile feedback based on the region within the displayed ultrasound image being touched by the user. As explained previously, a region of interest (ROI) or sample volume may be defined for a displayed image. For example, a user may manually position the ROI or sample volume on the displayed image, or the controller of the imaging system may automatically position or know the desired ROI or sample volume based on user inputs and/or stored image data of the scanned tissue. Thus, the ROI or sample volume for the displayed image may be known by the controller. In one embodiment, tactile feedback may be output via the display when the user is touching the display within a known (or pre-defined) ROI and not outside of it, or vice versa. In another embodiment, tactile feedback may be output as the user traces the border of the ROI and the controller may continue to provide the tactile feedback through the display as long as the user does not deviate from the border. In yet another embodiment, tactile feedback may be provided in different patterns (continuous, rapid pulse, slow pulse, strong vibration, weak vibration, etc.) depending on the intensity, or other image parameter values, of the pixel(s) beneath the user's finger, glove, stylus etc. For instance, a continuous vibration may be provided at a tissue boundary, whereas a series of pulses corresponding to gray scale, brightness or opacity may be output as the user drags their finger across regions devoid of borders. Tactile feedback output may also be modified based on the analytical tool being used within a region of an image being touched by the user, as discussed further below.

After adjusting tactile feedback based on system operating conditions at 404, method 400 continues to 416, where the system controller determines whether an input has been received requesting the placement or movement of one or more analytical tools when a desired placement is already known. As introduced above, user placement of analytical tools may include positioning of measurement calipers, positioning of an ROI, and/or positioning of a Doppler sample volume on the displayed image (e.g., by selection of the desired analytical tool and tracing on the image displayed on the touch-sensitive display to position the selected analytical tool). As one example, the method at 416 may include determining if the user has already positioned the selected analytical tool on the displayed image (e.g., already defined and set the ROI or sample volume for the displayed ultrasound image). In some embodiments, based on user inputs and/or stored image data, the controller may know a desired (or intended) ROI or sample volume for the displayed image (e.g., a particular vessel or structure of the imaged tissue). In one example, the user may request via one or more user inputs automatic snapping of an ROI, measurement calipers, and/or a Doppler sample volume into the desired/known location on the image being displayed, either from a live feed or stored image/video. In this way, an ROI or sample volume may already be automatically positioned on the image at 416 or a desired position of the selected analytical tool may be known.

If the controller has not received a request to move or place an analytical tool when a desired location of the selected analytical tool is already known, the method proceeds to 418, where the controller maintains the current tactile feedback parameters. Alternatively at 416, if the controller receives a signal that placement or repositioning of an analytical tool is requested when a desired position of the analytical is already known, the method proceeds to 420. At 420, the method includes providing tactile feedback resistance if the user attempts to move the analytical tool (e.g., ROI, measurement caliper, or Doppler sample volume) away from the desired or pre-set position. As explained above, the desired position of the analytical tool may be based on stored data in an image recognition database that takes into account tissue type, plane of view, ultrasound mode, etc. Stored data may also come from user inputs of images stored in a memory of the system. As yet another example, the desired position may be known based on a previous user placement of the analytical tool (e.g., a user may have previously drawn and set the ROI). In one example, resistance when attempting to move an analytical tool into an incorrect position may come in the form of an alternative tactile feedback pattern meant to convey error, such as a rapid fire pulsing of vibration, heat, etc. In the same example, when applied voltage is used as the mode of tactile feedback, resistance can be provided by increasing the amount of applied voltage. Increasing applied voltage proportionally increases the frictional forces between the user and screen, making it increasingly difficult for the user to slide their finger across the screen. In another embodiment, resistance may be output via the display in the form of a very intense tactile feedback output that is stronger than normal output signals. Resistance settings may be customizable by the user ahead of time during the method at 406. In this way, adjusting tactile feedback parameters based on operating conditions may lead to faster and more accurate positioning of analytical tools within the ultrasound image.

In this way, tactile feedback may be output to a user via an touch-sensitive display of an imaging system. For example, generated medical images (e.g., such as ultrasound images) may be displayed on the touch-sensitive display. When a user touches a region of the display that displays the generated medical image, a controller of the system may output tactile feedback through the display in the region being touched by the user. The tactile feedback may be based on the data content of the generated image. For example, each pixel of the display may represent the acquired medical imaging data and may be assigned a corresponding value, such as an intensity value. The tactile feedback output via the screen may then be based on the intensity values at the pixels touched by the user. As a result, a user may feel the tactile feedback as they fingers pass across the displayed image and learn details of the features of the image (e.g., edges, changes in color or intensity, tissue borders, etc.). A technical effect of outputting tactile feedback via a display that corresponds to data of the displayed image is allowing a user to understand the displayed image and position different analytical tools on the image without having to directly visualize the image. For example, if the user is placing a region of interest (ROI) or measurement calipers on the displayed image, their hands/fingers may obscure their view of the displayed image, thereby decreasing the accuracy of the positioning of the analytical tool and increasing a time for analyzing the image. By receiving tactile feedback via the display, a user may more easily and accurately position analytical tools with the touch-sensitive display. Further, when using smaller, portable touch-sensitive displays or using the displays in areas of decreased lighting, the tactile feedback may enable a user to understand the structural features of the displayed imaged tissue and make a more accurate medical diagnosis and/or more easily analyze the image.

In one embodiment, a method comprises acquiring medical imaging data with a medical imaging device, generating an image from the acquired data, displaying the image on a touch-sensitive display, and during user touching of the displayed image, outputting tactile feedback via the display based on the acquired data. The acquired data may include one or more image parameters calculated for each pixel or group of pixels of the display and wherein outputting tactile feedback may include outputting tactile feedback that is a function of the one or more calculated image parameters for one or more pixels in a region of the display that displays the image and is touched by the user. Calculated image parameters may include one or more of an intensity, velocity, color flow velocity, texture, graininess, contractility, deformation, and rate of deformation value.

As one example, the tactile feedback includes a vibration output via the display in the region touched by the user. For example, a degree of the vibration output via the display may be based on the one or more calculated image parameters.

In one embodiment, the degree of tactile feedback output via the display may be based on the one or more calculated image parameters for the one or more pixels in the region of the display touched by the user, and may further comprise increasing the degree of tactile feedback via the display as a value of the one or more calculated image parameters of the one or more pixel increases.

As another example, the tactile feedback includes an amount of heat output via the display in a region of the display touched by the user. As yet another example, the tactile feedback includes an applied voltage output via the display and the method may further include modulating said applied voltage to adjust the frictional forces between the user and the display based on the one or more calculated image parameters.

The method may further include adjusting the tactile feedback based on operating conditions of the medical imaging device, where the operating conditions include one or more of an imaging mode, user settings, screen size, a viewing angle of the image, a type of tissue being imaged, and a region of the display being touched by a user. Additionally, outputting tactile feedback may include outputting a first tactile feedback via the display in response to a signal indicating a user is touching the displayed image in a region of the displayed image not corresponding to an edge within the image. The method may further comprise, in response to receiving a signal that the user is touching the displayed image in a region corresponding to the edge within the image, outputting a second tactile feedback, different than the first tactile feedback, via the display in the region that corresponds to the edge.

Further still, the method may include, in response to receiving an input for positioning an analytical tool on the displayed image, displaying the analytical tool on the displayed image, via the display, as signals are received from a user touching the displayed image and further comprising, during displaying of the analytical tool, continuing to provide tactile feedback to the user via the display. As one example, the analytical tool includes one or more of a region of interest, measurement calipers, and a Doppler sample volume. The method may further comprise automatically adjusting placement of the analytical tool on the displayed image based on analysis of the generated image. In another example, the method may further include, during positioning of the analytical tool on the displayed image, providing tactile resistance via the display if a user attempts to position the analytical tool outside of a designated region, where the designated region is based on analysis of the generated image.

As another example, the method may comprise, after the analytical tool is positioned in the first position on the displayed image at a first feature of interest, providing tactile resistance via the display in response to a user moving the analytical tool away from the first position and decreasing the provided tactile resistance as the analytical tool approaches a second feature of interest in the displayed image.

As another embodiment, a method comprises acquiring medical imaging data with a medical imaging device, and during the acquiring, generating an image from the acquired data, displaying the image on a touch-sensitive display, and in response to receiving a signal indicating a user is touching a region of the displayed image on the display, outputting tactile feedback via the display based on data content of the acquired data corresponding to one or more pixels in the region touched by the user. The acquired data content may include one or more image parameters calculated for each pixel of the display. During acquisition the method may include continuously updating the displayed image and tactile feedback based on the acquired data. The method may further include outputting the tactile feedback on the same screen of the display that is displaying the image, while the image is being displayed.

As yet another embodiment, a method includes an ultrasound imaging system, comprising an ultrasound probe, a touch-sensitive display, and a controller with non-transitory memory. The controller with non-transitory memory includes instructions for acquiring ultrasound data via the ultrasound probe, generating an image from the acquired data, and displaying the image via the touch-sensitive display. Upon receiving a signal from the touch-sensitive display indicating a user is touching a region of the image on the display, the controller may then output tactile feedback in a form of one or more of heat, applied voltage, and vibration at the region, where an intensity of the heat, applied voltage, or vibration is based on an one or more image parameters determined from the acquired data and assigned to one or more pixels in the region.

As one example, the touch-sensitive display includes a first region for displaying the image and outputting the tactile feedback and a second region for displaying one or more user selectable elements. For example, the user selectable elements may include one or more inputs for adjusting tactile feedback settings, adjusting image display settings, and placing an analytical tool on the displayed image. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method, comprising:
acquiring medical imaging data with a medical imaging device;
generating an image from the acquired data;
displaying the image on a touch-sensitive display; and
during user touching of the displayed image, outputting tactile feedback via the display based on the acquired data.

2. The method of claim 1, wherein the acquired data includes one or more image parameters calculated for each pixel or group of pixels of the display and wherein outputting tactile feedback includes outputting tactile feedback that is a function of the one or more calculated image parameters for one or more pixels in a region of the display that displays the image and is touched by a user.

3. The method of claim 2, wherein the one or more calculated image parameters includes one or more of an intensity, velocity, color flow velocity, texture, graininess, contractility, deformation, and rate of deformation value.

4. The method of claim 2, wherein the tactile feedback includes a vibration output via the display in a region of the display touched by a user and wherein a degree of the vibration output via the display is based on the one or more calculated image parameters.

5. The method of claim 2, wherein a degree of the tactile feedback output via the display is based on the one or more calculated image parameters for the one or more pixels in the region of the display touched by the user and further comprising increasing or decreasing the degree of tactile feedback output via the display as a value of the one or more calculated image parameters of the one or more pixels increases.

6. The method of claim 2, wherein the tactile feedback includes an amount of heat output via the display in a region of the display touched by a user and wherein a degree of the heat output via the display is based on the one or more calculated image parameters.

7. The method of claim 2, wherein the tactile feedback includes an applied voltage output via the display and further comprising modulating said applied voltage to adjust frictional forces between a user touching the display and the display based on the one or more calculated image parameters.

8. The method of claim 1, further comprising adjusting the tactile feedback based on operating conditions of the medical imaging device, where the operating conditions include one or more of an imaging mode, user settings, screen size, a viewing angle of the image, a type of tissue being imaged, and a region of the display being touched by a user.

9. The method of claim 1, wherein outputting tactile feedback includes outputting a first tactile feedback via the display in response to a signal indicating a user is touching the displayed image in a region of the displayed image not corresponding to an edge within the image and further comprising in response to receiving a signal that the user is touching the displayed image in a region corresponding to the edge within the image, outputting a second tactile feedback, different than the first tactile feedback, via the display in the region that corresponds to the edge.

10. The method of claim 1, further comprising, in response to receiving an input for positioning an analytical tool on the displayed image, displaying the analytical tool on the displayed image, via the display, as signals are received from a user touching the displayed image and further comprising, during displaying of the analytical tool, continuing to provide tactile feedback to the user via the display.

11. The method of claim 10, wherein the analytical tool includes one or more of a region of interest, measurement calipers, and a Doppler sample volume and wherein the input for positioning the analytical tool includes one or more of a user selection of one or more user selectable elements displayed via the display, a user selection of one or more user selectable elements displayed after receiving an input that a user applied a force to the display, and an applied force to the display and corresponding unapplied force to the display upon selection of a desired analytical tool.

12. The method of claim 10, further comprising automatically adjusting placement of the analytical tool on the displayed image based on analysis of the generated image.

13. The method of claim 10, further comprising, during positioning of the analytical tool on the displayed image, providing tactile resistance via the display if a user attempts to position the analytical tool outside of a designated region, where the designated region is based on analysis of the generated image.

14. The method of claim 10, further comprising, after the analytical tool is positioned in a first position on the displayed image at a first feature of interest, providing tactile resistance via the display in response to a user moving the analytical tool away from the first position and decreasing the provided tactile resistance as the analytical tool approaches a second feature of interest in the displayed image.

15. A method, comprising:
acquiring medical imaging data with a medical imaging device; and
during the acquiring:
generating an image from the acquired data;
displaying the image on a touch-sensitive display; and
in response to receiving a signal indicating a user is touching a region of the displayed image on the display, outputting tactile feedback via the display based on data content of the acquired data corresponding to one or more pixels in the region touched by the user.

16. The method of claim 15, wherein the data content includes one or more image parameters calculated for each pixel of the display.

17. The method of claim 15, further comprising during the acquiring, continuously updating the displayed image and tactile feedback based on the acquired data.

18. An ultrasound imaging system, comprising:
an ultrasound probe;
a touch-sensitive display;
a controller with non-transitory memory including instructions for:
acquiring ultrasound data via the ultrasound probe;
generating an image from the acquired data;
displaying the image via the touch-sensitive display; and
upon receiving a signal from the touch-sensitive display indicating a user is touching a region of the image on the display, outputting tactile feedback in a form of one or more of heat, applied voltage, and vibration at the region, where an intensity of the heat, applied voltage, or vibration is based on one or more image parameters determined from the acquired data and assigned to one or more pixels in the region.

19. The system of claim 18, wherein the touch-sensitive display includes a first region for displaying the image and outputting the tactile feedback and a second region for displaying one or more user selectable elements.

20. The system of claim 19, wherein the user selectable elements includes one or more of inputs for adjusting tactile feedback settings, adjusting image display settings, and placing an analytical tool on the displayed image.
